(19) United States
(12) Patent Application Publication
(10) Pub. No.: US 2019/0134585 A1
(43) Pub. Date: May 9, 2019

(54) SYNTHESIS OF OXYGEN AND BORON TRIHALOGENIDE FUNCTIONALIZED TWO-DIMENSIONAL LAYERED MATERIALS IN PRESSURIZED MEDIUM

(71) Applicants: Boron Nitride Power, LLC, Chicago, IL (US); University of Kansas, Lawrence, KS (US)

(72) Inventors: Karoly Nemeth, Darien, IL (US); Andrew M. Danby, Lawrence, KS (US); Bala Subramaniam, Lawrence, KS (US)

(21) Appl. No.: 16/099,806

(22) PCT Filed: May 8, 2017
(86) PCT No.: PCT/US2017/031579

§ 371 Date: Nov. 8, 2018

Related U.S. Application Data
(60) Provisional application No. 62/333,272, filed on May 9, 2016.

(51) Int. Cl. B01J 3/00; C01B 32/19; C01B 21/064; C01B 19/04; C01B 17/20; C01B 32/90; C01B 21/082; C01B 21/06

(52) U.S. Cl. CPC B01J 3/008; C01B 32/19; C01B 21/0648; C01B 19/04; C01P 2002/76; C01B 32/90; C01B 21/0828; C01B 21/06; C01P 2004/20; C01B 17/20

(57) ABSTRACT

A method that uses a pressurized reactive medium composed of inert solvents such as pressurized liquid or supercritical fluid carbon dioxide (C02), and sulfur hexafluoride (SF6) and reactive dissolved species ozone (03) and/or boron trifluoride (BF3) and general boron trihalogenides (BX3) to react with two-dimensional (2D) layered materials and thereby synthesize covalently oxygen and/or BX3 functionalized exfoliated 2D layered materials. When 2D layered materials are dispersed in these reactive liquids or fluids by ultrasound sonication or high shear mixing, a simultaneous covalent functionalization and exfoliation of the 2D layered materials happens. Following attainment of the required extent of functionalization and exfoliation, the unreacted 03, BX3, SF6 and C02 can be easily removed as gases by decompression leaving behind the solid phase, thereby leading to efficient and economical production of functionalized and exfoliated 2D layered materials.

### CROSS-REFERENCE TO RELATED APPLICATION(S)

This application claims priority to U.S. Provisional Application No. 62/333,272, “Synthesis of Oxygen Functionalized Hexagonal Boron Nitride”, filed May 9, 2016, to the extent allowed by law and the contents of which are incorporated herein by reference in their entireties.

### TECHNICAL FIELD

The present disclosure is related to a method for the synthesis of oxygen and boron trifluoride functionalized mono- or few-layers of two-dimensional (2D) layered materials. The method for the synthesis uses a pressurized mechanically agitated medium composed of inert species, such as SF₆, CO₂, and reactive species O₃ and BF₃ (or general boron trihalogenides, BX3) gases such that the gases form a liquid or a supercritical fluid phase at temperatures and pressures close to their critical points. The good mixing of the component gases in these phases is aided by the introduction of ultrasound or high shear mixing that also promotes the exfoliation of the 2D materials. When 2D layered solid materials are dispersed and ultrasound-sonicated or high shear mixed in these reactive media, the reaction of O₃ and/or BF₃ with the dispersed solid material happens resulting in simultaneous covalent functionalization and exfoliation of the 2D layered material. Once the required extent of functionalization and exfoliation is achieved, the gases/liquids can be removed by decompressing the reaction medium. This synthesis allows for the efficient and economic synthesis of functionalized and exfoliated 2D layered materials.

### BACKGROUND

The recent discovery of the solubility of ozone (O₃) in liquid carbon dioxide (lqCO₂), liquid sulfur hexafluoride (lqSF₆) and CO₂ expanded solvents allows for the oxidation of materials in pressurized, liquid or supercritical CO₂ (scCO₂) medium as described in B. Subramaniam, D. Busch, A. M. Danby, T. P. Binder: “Ozonolysis reactions in Liquid CO₂ and CO₂-expanded Solvents”, U.S. Pat. No. 8,801,939 and in M. D. Lundin, A. M. Danby, G. R. Akien, T. P. Binder, D. H. Busch and B. Subramaniam: “Liquid CO₂ as a Safer and Benign Solvent for the Ozonolysis of Fatty Acid Methyl Esters” ACS Sustainable Chem. Eng., 2015, 3 (12), pp 3307-3314, both incorporated fully by reference. As described by B. Subramaniam in P. T. Anastas and J. B. Zimmerman, “Innovations in Green Chemistry and Green Engineering: Selected Entries from the Encyclopedia of Sustainability Science and Technology”, Springer, 2012, ISBN 146145817X, 9781461458173, page 21, ozone is a potent oxidation agent with high oxidation potential (Eo=2.07 V in acid and Eo=2.26 V in base). In the temperature range close to its critical temperature (−12.1° C., typically between 0-20 degrees Celsius (° C.), compressing ozone beyond its critical pressure (55.6 bar) results in a liquid-like ozone density. In the same temperature and pressure range, CO₂ or SF₆ exists as liquid and the O₃ content of this liquid can be conveniently tuned by changing the pressure. Ozone does not react with CO₂, thus it is an ideal solvent that does not consume away O₃ from the targeted reaction. Furthermore, ozone is stable in lqCO₂ and its half-life is about 6 hours.

The intermolecular interactions between SF₆, CO₂, O₃ and BF₃ are essentially weak van der Waals interactions that lead to the formation of loose complexes and adducts that have been studied in the scientific literature to some extent. CO₂ and BF₃ stabilize O₃, meaning that they do not let O₃ to decompose explosively in liquid and supercritical phases, which pure O₃ would otherwise tend to do. The mechanism of this stabilization is not well known despite the extensive use of CO₂ stabilized O₃ as referred to in the above cited literature. BF₃ is expected to form similar complexes with O₃ as what it forms with ethers. The interaction of BF₃ and CO₂ results in loose van der Waals complexes, as pointed out in synthesis works, by spectroscopy and by theoretical calculations in K. R. Leopold, G. T. Fraser and W. Klemperer: “Rotational spectroscopy of molecular complexes of boron fluoride with NCCN, CO₂, and N₂O”, Journal of the American Chemical Society 106, no. 4 (1984): 897-899; L. M. Nxumalo, and T. A. Ford: “The Fourier transform infrared spectrum of the boron trifluoride-carbon dioxide complex”, Journal of molecular structure 436 (1997): 69-80; L. M. Nxumalo, G. A. Yeo and T. A. Ford: “The vibrational spectra of the boron halides and their molecular complexes, part 5 An ab initio study of the infrared spectrum of the boron trifluoride-carbon dioxide complex”, Theoretical Chemistry Accounts: Theory, Computation, and Modeling (Theoretica Chimica Acta) 96, no. 3 (1997): 157-165; and in C. V. de Macedo, M. S. da Silva, T. Casimiro, E. J. Cabrita, and A. Aguiar-Ricardo: “Boron trifluoride catalyzed polymerisation of 2-substituted-2-oxazolines in supercritical carbon dioxide”, Green Chemistry 9, no. 9 (2007): 948-953.

Ultrasound sonicated high-pressure medium, such as supercritical CO₂, allows for the efficient exfoliation of layered materials, such as hexagonal boron nitride, graphene and others (V. Stengl, J. Henych, M. Slusna and P. Ecorhard: “Ultrasound exfoliation of inorganic analogues of graphene”, Nanoscale Research Letters 9, no. 1 (2014): 167 and Y. Wang, C. Zhou, W. Wang and Y. Zhao: “Preparation of Two Dimensional Atomic Crystals BN, WS2, and MoS2 by Supercritical CO₂ Assisted with Ultrasound”, Ind. Eng. Chem. Res. 52, no. 11 (2013): 4379-4382). In this exfoliation technique, high pressure CO₂ penetrates between the layers of the 2D layered material when there are sudden openings between the layers through intense ultrasonication. Exfoliation of graphite to graphene has also been carried out in ultrasonicated scCO₂, see for example W. Wang, Y. Wang, Y. Gao and Y. Zhao: “Control of number of graphene layers using ultrasound in supercritical CO₂ and their application in lithium-ion batteries”, The Journal of Supercritical Fluids 85 (2014): 95-101. From these latter works, it is clear that the high-energy ultrasound not only exfoliates the 2D layered material, but also cuts it into smaller pieces reducing the lateral size of the resulting flakes. Other exfoliation methods include wet processing in solvents containing Lewis bases such as the ones described in Y. Lin and J. W. Connell: “Method for exfoliation of hexagonal boron nitride”, U.S. Pat. No. 8,303,922 B2 (2012), however, these methods did not make use of a (lq/sc)CO₂ medium and do not aim on obtaining functionalized hexagonal boron nitride.

A less energetic way of separating layers of 2D layered materials is via shear force using high shear mixing in an appropriate liquid or fluid medium, as described by K. R. Paton, E. Varrla, C. Backes, R. J. Smith, U. Khan, A. O'Neill, C. Boland, M. Lotya, O. M. Istrate, P. King, T. Higgins, S. Barwich, P. May, P. Puczkarski, I. Ahmed, M. Moebius, H. Pettersson, E. Long, J. Coelho, S. E. O'Brien, E. K. McGuire, B. M. Sanchez, G. S. Duesberg, N. McEvoy, T. J. Pennycook, C. Downing, A. Crossley, V. Nicolosi and J. N. Coleman in “Scalable production of large quantities of defect-free few-layer graphene by shear exfoliation in liquids”, Nature materials 13, no. 6 (2014): 624-630. This technique also allows for a large scale production of defect-free exfoliated 2D materials. The shear force based exfoliation translates the neighboring layers relative to each other as long as they completely separate. This translation of the neighboring layers can be carried out without the application of high pressure and the high energy ultrasound in the previously described exfoliation method. Thus the application of the shear force method saves energy and improves the quality and the lateral size of the exfoliated material.

It is also known that 2D materials can be covalently functionalized, in other words, chemical functional groups can be attached to their surfaces via covalent bonds. For example, hexagonal boron nitride can be functionalized covalently by several chemical species, such as hydroxyl radicals, as described in A. S. Nazarov, V. N. Demin, E. D. Grayfer, A. I. Bulavchenko, A. T. Arymbaeva, H-J. Shin, J-Y. Choi and V. E. Fedorov. “Functionalization and Dispersion of Hexagonal Boron Nitride (h-BN) Nanosheets Treated with Inorganic Reagents”, Chem. Asian J. 2012, 7, 554-560. Charge transfer complexes between strong Lewis acids/bases and planar conjugated pi-electron systems are also well known. In the following, the definition of functionalization may involve either covalent or charge-transfer based functionalization.

Graphite and graphene can also be covalently functionalized. For example, the reaction of ozone with graphene oxide in aqueous solutions has been studied by F. Yang, M. Zhao, Z. Wang, H. Ji, B. Zheng, D. Xiao, L. Wu, and Y. Guo in “The role of ozone in the ozonation process of graphene oxide: oxidation or decomposition?”, RSC Advances 4, no. 102 (2014): 58325-58328. The oxygen functionalization of graphene via reactions with ozone gas was also studied, for example, by A. N. Rider, Q. An, E. T. Thostenson and N. Brack in: “Ultrasonicated-ozone modification of exfoliated graphite for stable aqueous graphitic nanoplatelet dispersions”, Nanotechnology 25, no. 49 (2014): 495607 and by Zhang, Ziyu, Haihua Tao, Hao Li, Guqiao Ding, Zhenhua Ni, and Xianfeng Chen in “Making few-layer graphene photoluminescent by UV ozonation”, Optical Materials Express 6, no. 11 (2016): 3527-3540.

Another work that applies UV irradiation in an oxygen containing environment to oxygen-functionalize 2D materials is described in A. A. Bessonov, M. N. Kirikova and D. I. Petukhov: “Method and apparatus for oxidation of two-dimensional materials”, PCT/RU2014/000133, WO2015130189A1 (2015). Note that this work does not make use of any exfoliation. It appears that the 2D object in this work is deposited as ultra-thin layer from the gas phase before oxidation therefore there is no need for further exfoliation.

Recent comprehensive reviews of graphene oxide and functionalized hexagonal boron nitride with illustrations on the respective chemical bonding structures can be found in D. R. Dreyer, S. Park, C. W. Bielawski, and R. S. Ruoff: “The chemistry of graphene oxide”, Chemical Society Reviews 39, no. 1 (2010): 228-240, and in Q. Weng, X. Wang, X. Wang, Y. Bando and D. Golberg: “Functionalized hexagonal boron nitride nanomaterials: emerging properties and applications”, Chemical Society Reviews 45, no. 14 (2016): 3989-4012.

Catalysts, such as boron trifluoride (BF₃), aluminum and ferric chlorides (AlCl₃ and FeCl₃) accelerate the ozonation of aromatic hydrocarbons as reviewed in P. S. Bailey: “The reactions of ozone with organic compounds”, Chemical Reviews 58, no. 5 (1958): 925-1010.

Not all functionalized 2D materials are safe and stable. For example, graphene oxide is known to explosively decompose at relatively low temperatures (200-300° C.), as reviewed in F. Kim, J. Luo, R. Cruz-Silva, L. J. Cote, K. Sohn and J. Huang: “Self-propagating domino-like reactions in oxidized graphite”, Advanced Functional Materials 20, no. 17 (2010): 2867-2873, and in D. Krishnan, F. Kim, J. Luo, R. Cruz-Silva, L. J. Cote, H. D. Jang, and J. Huang: “Energetic graphene oxide: challenges and opportunities”, Nano today 7, no. 2 (2012): 137-152. The possibility of explosive decomposition of graphene oxide is a major obstacle for the large scale production and storage of graphene oxide.

Oxygen functionalized h-BN is stable at 800° C. or even higher as pointed out for example in L. H. Li, J. Cervenka, K. Watanabe, T. Taniguchi, and Y. Chen: “Strong oxidation resistance of atomically thin boron nitride nanosheets”, ACS nano 8, no. 2 (2014): 1457-1462, and in Z. Cui, A. J. Oyer, A. J. Glover, H. C. Schniepp and D. H. Adamson: “Large scale thermal exfoliation and functionalization of boron nitride”, Small 10, no. 12 (2014): 2352-2355. Another example of reacting h-BN with oxygen molecules (O2) at high temperature and thereby oxygen-functionalizing it is given in D. H. Adamson and Z. Cui: “Methods of Modifying Boron Nitride and Using Same”, PCT/US2014/017420, WO 2014130687 A1 (2014).

Hummers' method, as described in W. S. Hummers Jr, and R. E. Offeman: “Preparation of graphitic oxide”, Journal of the American Chemical Society 80, no. 6 (1958): 1339-1339, and its modifications have been used for the laboratory scale production of graphene oxide. This method uses strong oxidizing agents, such as KMnO₄ in concentrated sulfuric acid with added concentrated hydrogen peroxide and other oxidizing agents such as NaNO₃, in a highly exothermic reaction which also produces toxic and explosive gas (such as NO₂ and N₂O₄). A modified Hummers' method has also been used to produce oxygen functionalized hexagonal boron nitride, for example in P. M. Sudeep, S. Vinod, S. Ozden, R. Sruthi, A. Kukovecz, Z. Konya, R. Vajtai, M. R. Anantharaman, P. M. Ajayan, and T. N. Narayanan. “Functionalized boron nitride porous solids”, RSC Advances 5, no. 114 (2015): 93964-93968.

Since aqueous medium is used in Hummers' method, the functional groups attached to graphene or h-BN will have a large proportion of hydroxyl groups, instead of pure oxygen functionalization. In addition, purification and drying of the product requires significant additional effort and care.

To date, no simultaneous oxygen functionalization and exfoliation of graphene, hexagonal boron nitride (h-BN) or other 2D layered materials has been reported in either liquid or supercritical carbon dioxide solvent using ozone (O₃) as oxidation agent. The combination of dense CO₂ solvent and O₃ oxidant with ultrasound or high shear mixing assisted exfoliation promises several significant advantages as compared to the aforementioned oxidation and exfoliation techniques. A CO₂ solvent is expected to either suppress or eliminate the potentially explosive oxidative decomposition of graphene-oxide, especially when applied at relatively low sub-ambient temperatures, thus opening a path to the safe large scale production and storage of graphene oxide. Besides safety, the use of O₃ in CO₂ counts also as environmentally friendly and is quite economical. No byproducts are produced as opposed to the previously reported methods; the unreacted O₃ spontaneously decomposes to dioxygen within days if not hours and CO₂ is environmentally compatible. Furthermore, the purification and drying steps of previously used methods can be completely eliminated, as the final product is obtained after decompressing and thereby evaporating the CO₂ solvent and the O₃ or O₂ gases present. The O₃ oxidation agent can be produced using pure O₂ from a tank or even from air by existing O₃ generating techniques such as in electric (corona) arc discharge. This saves transportation and handling costs of reagents and by-products as compared to previously used methods.

BF₃ catalyst/reagent is highly miscible with O₃, SF₆ and CO₂. The critical temperature and pressure of BF₃ (Tc=−12.35° C., pc=49.8 bar) and O₃ (Tc=−12.1° C., pc=55.6 bar) are almost identical, while those of CO₂ are a bit farther from these values but still close (Tc=31.1 degrees C., pc=73.8 bar). The critical point of SF₆ is also close (Tc=−45.5° C., pc=37.59 bar). This feature of BF₃ allows for its use as catalyst and/or medium of ozonation or also as a reactant to further functionalize the (oxidized) 2D materials in a supercritical mix of BF₃ and O₃ that may contain supercritical or liquid CO₂ or SF₆ as well. Furthermore, BF₃ has been applied to stabilize liquid O₃ in the past as described in A. Roaldi and L. J. S. Logan: “Stabilized liquid ozone composition containing a boron trifluoride complex”, U.S. Pat. No. 3,260,627 A (1966). In the case reagent amount of BF₃ is applied as compared to the amount of 2D materials present, a mixed —F and —O—BF₂ functionalization of the 2D materials can be expected, similarly to the application of BF₃ to graphene oxide in organic solvents as described in K. Samanta, S. Some, Y. Kim, Y. Yoon, M. Min, S. Mi Lee, Y. Park, and H. Lee: “Highly hydrophilic and insulating fluorinated reduced graphene oxide”, Chemical Communications 49, no. 79 (2013): 8991-8993.

Additional benefits from using BF₃ as a medium or additive accrue from the fact that BF₃ interacts with the surface of most 2D layered materials via a relatively strong van der Waals and electrostatic interaction. For example, the interaction of BF₃ with h-BN layers is similarly strong as that of h-BN layers with each other due to the strong electrostatic polarization of both planar molecules, thus BF₃ can relatively easily penetrate between h-BN layers helping the exfoliation and later the dispersion of the h-BN particles. Similar properties of ionic liquids have been successfully utilized to exfoliate graphite, h-BN and other 2D layered materials even at mild ultrasonication, as discussed in T. Morishita, H. Okamoto, Y. Katagiri, M. Matsushita, and K. Fukumori: “A high-yield ionic liquid-promoted synthesis of boron nitride nanosheets by direct exfoliation”, Chemical Communications 51, no. 60 (2015): 12068-12071. As mentioned in this work, surface energies of 2D materials can be well matched to surface energies of ionic liquids (as calculated from their surface tensions), thus a properly selected ionic liquid solvent can exfoliate 2D layered materials relatively easily and can stabilize it in dispersion. The disadvantage of using ionic liquids is that their removal from the surface of the 2D layered materials is very cumbersome especially given their extremely low volatility. BF₃ has the advantage that it leaves as a gas when the system is sufficiently decompressed.

In case of reacting the 2D layered material molybdenum disulfide (MoS₂) with BF₃ in supercritical BF₃ (scBF₃) or scBF₃/(lq/sc)CO₂ mixtures, thiolate like adducts of BF₃ with the sulfur atoms of MoS₂ layers form, similar to BF₃-thiolates mentioned in the previously cited work. Similar functionalization happens for other 2D layered transition metal dichalcogenides with BF₃.

Although the critical points of other boron trihalogenides, such as BCl₃ (Tc=182° C., pc=38.7 bar) and BBr₃ (Tc=308° C., pc=unknown) are very much different from those of O₃ and BF₃, BCl₃ and BBr₃ are liquids in the typical temperature range of the O₃/CO₂ ozonations (0-20° C.) in a broad pressure range. Furthermore, the intermolecular interactions of BCl₃ and BBr₃ with 2D layered materials and ozone are very similar to those of BF₃. Therefore, besides BF3, also general boron trihalogenides BX1X2X3 with X1, X2, X3=Flourine, Chlorine, Bromine, Iodine, expressed simply as BX3 from now on, will be considered in the present exfoliation/functionalization approach to 2D layered materials.

The above proposed principles of oxygen and BX3 functionalization of 2D materials can be applied to many classes of 2D materials, such as III-V group materials (containing at least one group III element and at least one group V element of the periodic table), for example BN, BCN, BP, BAs, AlN, GaN, InN, InP, InAs, GaP; transition metal dichalcogenides, such as TX2 with T═Mo, W, Sc, Ti, Hf, Zr, V, Cr, Mn, Fe, Co, Ni, Nb, Tc, Re, Pd, Pt, and X═S, Se, Te; xenes (silicene, stanene, etc.) and mxenes, such as Ti₂C, (Ti0.5,Nb0.5)2C, V₂C, Nb₂C, Mo₂C, Ti₃C₂, Ti₃CN and Zr3C₂, Ti₄N₃, Nb₄C₃, Ta₄C₃, Mo₂TiC₂, Cr₂TiC₂, Mo₂Ti₂C₃; and so-called MAX-Phases (layered and intercalated 2D ternary transition metal carbides and nitrides). MAX-Phases have recently been reviewed in M. Radovic and Michel W. Barsoum: “MAX phases: bridging the gap between metals and ceramics”, American Ceramics Society Bulletin 92, no. 3 (2013): 20-27. Xenes and mxenes have been recently reviewed in G. R. Bhimanapati, Z. Lin, V. Meunier, Y. Jung, J. Cha, S. Das, D. Xiao, Y. Son, M. S. Strano, V. R. Cooper, L. Liang, S. G. Louie, E. Ringe, W. Zhou, S. S. Kim, R. R. Naik, B. G. Sumpter, H. Terrones, F. Xia, Y. Wang, J. Zhu, D. Akinwande, N. Alem, J. A. Schuller, R. E. Schaak, M. Terrones, and J. A. Robinson: “Recent advances in two-dimensional materials beyond graphene”, Acs Nano 9, no. 12 (2015): 11509-11539.

The catalytic effect of BX3 in ozonation, the similar intermolecular interaction of BX3 with 2D layered materials and ozone, and the similar critical points of O₃, SF₆, CO₂ and BF₃ as well as liquid phases of BX3 allow for good miscibility of these substances in pressurized phases. These in turn make oxygen, BX3 or a mixed functionalization of 2D materials possible, and render these inventions to be discussed jointly.

Applications of functionalized 2D materials cover a broad area which includes composite materials, polymers, energy storage devices, electronics, medical applications and many other fields.

### SUMMARY

This disclosure relates generally to a method for the synthesis of covalently functionalized and exfoliated two-dimensional layered materials. One implementation of the teachings herein is a method for the synthesis of covalently functionalized and exfoliated two-dimensional layered materials that includes providing a two-dimensional (2D) layered material; providing an inert solvent comprising chemical species that do not participate in any reactions during the synthesis; providing a primary mixture comprising a plurality of components including at least one of the inert solvent and at least one reactive component, the at least one reactive component including at least one of ozone (O3) and boron trihalogenide, the boron trihalogenide represented by BX₁X₂X₃, where X₁, X₂, and/or X₃ are selected from the group consisting of fluorine, chlorine, bromine, and iodine, wherein each component is present in any percentage of the 0 and 100 percentage range of a total of all molecules of the primary mixture; setting a temperature and pressure of the primary mixture, wherein the primary mixture is one of liquid and supercritical fluid at the set temperature and pressure; providing a secondary mixture comprising the two-dimensional layered material and the primary mixture, wherein the secondary mixture is configured to allow a chemical reaction between the 2D layered material and the at least one reactive component of the primary mixture; applying mechanical agitation to the secondary mixture promoting mixing of the primary mixture and dispersion and exfoliation of the 2D layered material; allowing time for the reaction to proceed based on a desired extent of functionalization and exfoliation of the 2D layered material; and isolating the functionalized and exfoliated 2D layered material from a reaction product.

These and other aspects of the present disclosure are disclosed in the following detailed description of the embodiments, the appended claims and the accompanying FIGURE.

### BRIEF DESCRIPTION OF THE DRAWINGS

The various features, advantages, and other uses of the method will become more apparent by referring to the following detailed description and drawings, wherein like reference numerals refer to like parts.

FIG. 1. depicts Fourier-Transform Infrared (FT-IR) spectra of oxygen functionalized h-BN as obtained by ozonation of h-BN in ultrasonicated liquid CO₂ and that of untreated hexagonal boron nitride. The spectra were obtained from solid samples deposited on ZnSe plates from diethyl-ether slurry and dried in vacuum. It can clearly be seen that the two spectra are very similar, except the peaks in the regions of about 900-1200 cm-1 and 2800-3000 cm-1 which are signatures of covalent oxygen-functionalization of boron atoms in h-BN.

### DETAILED DESCRIPTION

The present disclosure makes use of a mechanically agitated reactive medium composed of inert solvent species such as pressurized liquid or supercritical fluid carbon dioxide (CO₂) or sulfur hexafluoride (SF₆), and reactive species of ozone (O₃) and boron trifluoride (BF₃) and general boron trihalogenides BX₃ to react with two-dimensional (2D) layered materials and thereby synthesize covalently oxygen and/or BF₃ functionalized exfoliated 2D layered materials. The reason for coupling these four types of species together for the synthesis is based on (a) the almost identical critical temperature and pressure of O₃ and BF₃ and the sufficiently close critical points of SF₆ and CO₂, (b) the similar catalytic effect and intermolecular interactions of BX₃ with 2D layered materials and ozone, and (c) the existence of liquid phases of BX₃ under the typical ozonation and exfoliation temperature/pressure conditions. Various combinations of these species may be used for specific targeted syntheses. For example, some preferred combinations include O₃/CO₂, O₃/BX₃ or BX₃/CO₂. The BX₃ may also be used by itself. When 2D layered materials are dispersed in these reactive liquids or fluids by ultrasound sonication or high shear mixing, a simultaneous covalent functionalization and exfoliation of the 2D layered materials happens. After reaching the required extent of functionalization and exfoliation, the unreacted species can easily be removed by decompressing the medium thereby leading to efficient and economic production of functionalized and exfoliated 2D layered materials.

The present disclosure utilizes the liquid and supercritical phases that can be made of inert solvents such as liquid or supercritical fluid SF₆ and CO₂ and reactive species O₃ and general boron trihalogenides, BX₃. The good mixing and solubility of these species in each other is ensured by the almost identical critical points of O₃ and BF₃ which allows for mixing O₃ and BF₃ in any ratio in the supercritical phase, as well as by the existence of liquid phases of BX₃ and the solubility of ozone in them. The critical points of SF₆ and CO₂ are somewhat different from those of O₃ and BF₃, however, as described in previous works cited above, O₃ dissolves in large concentrations in lqCO₂ and lqSF₆. Furthermore, SF₆, CO₂, O₃ and BX₃ do not react with each other, instead they form loose van der Waals complexes and adducts, as also pointed out in literature cited above. When these reactive phases are brought in contact with layered 2D materials they functionalize the surface and the edges of layers of these materials. Mechanical agitation using ultrasound sonication or high shear mixing is applied to disperse and exfoliate the 2D layered materials in these reactive media resulting in the exfoliated functionalized 2D layered materials. The exfoliated and functionalized material can be collected after the medium is decompressed and all gaseous/liquid molecules leave through a filter that holds back the solid particles.

In one implementation, the method of mechanical agitation includes the use of high shear mixing that generates shear forces on the layers of the 2D layered materials and thereby translates them relative to each other parallel with the basal planes of these materials. This results in a reduced energy need of exfoliation and a better preservation of the lateral size of exfoliated particles, while also reducing the amount of lattice defects due to ultrasound sonication. High shear mixing is especially advantageous when the liquid/fluid medium has sufficiently large viscosity. Otherwise, in an alternate implementation, the method of mechanical agitation includes ultrasound sonication that creates cavities in the medium and opens gaps between layers of 2D layered materials that will be penetrated by molecules of the medium leading to the separation of layers.

In a first embodiment, graphite or hexagonal boron nitride is immersed in a mechanically agitated liquid or supercritical mixture of CO₂ with large concentration of O₃ resulting in oxygen functionalized exfoliated 2D particles. Note that a large concentration of CO₂, in other words, a CO₂ solvent, is always recommended when graphite or graphene or other carbonaceous particles are oxygen functionalized. The high concentration of CO₂ and the relatively low temperature of the reaction with O₃ is important to avoid thermal decomposition of large fractions of the oxygen functionalized exfoliated carbonaceous species. BCN is another example of 2D layered carbonaceous species besides graphite that can be functionalized by this method.

In a second embodiment, a catalytic amount of BF₃ is added to the mixture of CO₂ and O₃ to carry out the first embodiment. In this case the final product will partially be functionalized by BF₃ as well.

In a third embodiment, a mixture of BF₃ and O₃ is used in the liquid or supercritical phase with mechanical agitation to functionalize and exfoliate h-BN and other binary III-V group materials.

In a fourth embodiment, mechanically agitated liquid or supercritical BF₃ is used to BF₃ functionalize and exfoliate transition metal chalcogenides.

In a fifth embodiment, xenes, mxenes and MAX-Phases are oxygen and/or BF₃ functionalized using a liquid or supercritical mixture of CO₂, O₃ and BF₃, following the above general methods.

In a sixth embodiment, graphite, h-BN, BNC and other III-V group 2D layered materials are exfoliated and functionalized in mechanically agitated liquid or supercritical BF₃. Note that in some cases, such as for graphite and h-BN, only a small amount of functionalization will happen, mostly on the edges of the 2D layers, in the BF₃ medium, while exfoliation may become complete to monolayers, depending on the reaction time given.

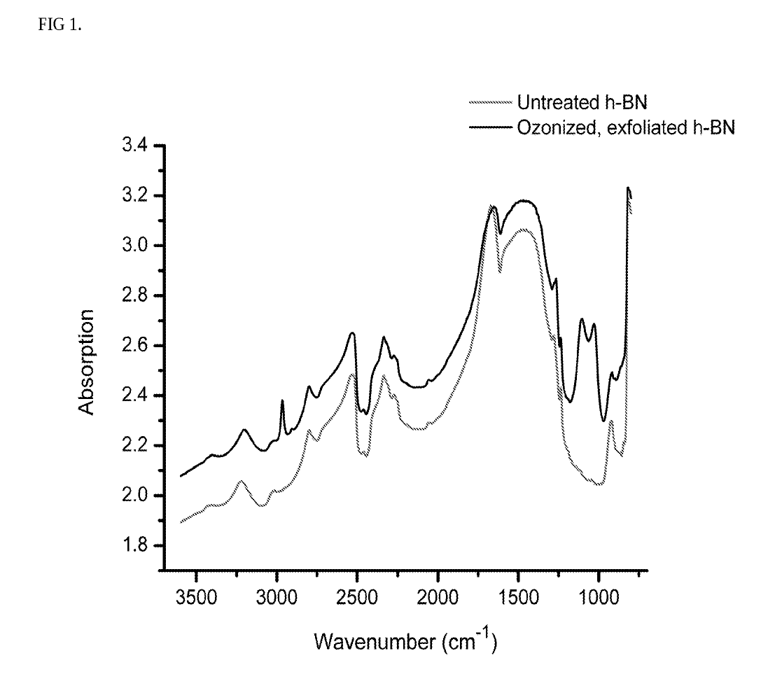

An exemplary experiment of oxygen functionalization of h-BN using O₃ dissolved in lqCOz is as follows: the same apparatus has been used as in U.S. Pat. No. 8,801,939 cited above. Before the O₃ addition, the BN sample (about 200 mg) has been soaked in lqCOz for about an hour at a temperature of T=10° C. and a pressure of p=800 psi (or ˜55 bar). Then O₃ has been added at T=12° C. and p=1310 psi (or ˜90 bar). This was followed by ultrasound sonication for 62 minutes at pulsed ultrasound power that kept the pressure below 1500 psi (103 bar) while the temperature rose to between 35 and 36° C. Finally the system was decompressed and the solid particles collected for analysis. Fourier Transform Infrared Spectroscopy (FT-IR) indicates successful oxygen functionalization of h-BN, as shown in FIG. 1. It is to be understood that various changes in the details, materials, arrangements of parts and components and methods which have been described and illustrated herein in order to explain the nature of the synthesis of oxygen and BF₃ functionalized materials that may be made by those skilled in the art within the principle and scope of the synthesis of oxygen and BF₃ functionalized materials as expressed in the appended claims. Furthermore, while various features have been described with regard to particular embodiments and methods, it will be appreciated that features described for one embodiment also may be incorporated with the other described embodiments.

All publications and patent documents cited in this application are incorporated herein by reference in their entirety for all purposes to the same extent as if each individual publication or patent document were so individually denoted.

Any element in a claim that does not explicitly state “means for” performing a specified function, or “step for” performing a specific function, is not to be interpreted as a “means” or “step” clause as specified in 35 U.S.C. § 112, ¶6. In particular, the use of“step of” in the claims herein is not intended to invoke the provisions of 35 U.S.C. § 112, ¶6.

While the present disclosure has been described in connection with certain embodiments, it is to be understood that the invention is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for the synthesis of covalently or charge transfer functionalized and exfoliated two-dimensional layered materials comprising:
providing a two-dimensional (2D) layered material;
providing an inert solvent comprising chemical species that do not participate in any reactions during the synthesis;
providing a primary mixture comprising a plurality of components including at least one of the inert solvent and at least one reactive component, the at least one reactive component including at least one of ozone (O₃) and boron trihalogenide, the boron trihalogenide represented by BX₁X₂X₃, where X₁, X₂, and/or X₃ are selected from the group consisting of fluorine, chlorine, bromine, and iodine;
setting a temperature and pressure of the primary mixture, wherein the primary mixture is one of liquid and supercritical fluid at the set temperature and pressure;
providing a secondary mixture comprising the two-dimensional layered material and the primary mixture, wherein the secondary mixture is configured to allow a chemical reaction between the 2D layered material and the at least one reactive component of the primary mixture;
applying mechanical agitation to the secondary mixture promoting mixing of the primary mixture and dispersion and exfoliation of the 2D layered material;
allowing time for the reaction to proceed based on a desired extent of functionalization and exfoliation of the 2D layered material; and
isolating the functionalized and exfoliated 2D layered material from a reaction product.

2. The method of claim 1, wherein the inert solvent is at least one of carbon dioxide (CO₂) and sulfur hexafluoride (SF₆).

3. The method of claim 1, wherein the mechanical agitation is ultrasound sonication.

4. The method of claim 1, wherein the mechanical agitation is high shear mixing.

5. The method of claim 1, wherein the two-dimensional layered material is from a periodic table class of III-V group materials.

6. The method of claim 5, wherein the two-dimensional layered material from the class of periodic table III-V group materials is selected from the group consisting of hexagonal boron nitride (BN), boron carbon nitride (BCN), boron phosphide (BP), boron arsenide (BAs), aluminum nitride (AlN), gallium nitride (GaN), indium nitride (InN), indium phosphide (InP), indium arsenide (InAs), and gallium phosphide (GaP).

7. The method of claim 1, wherein the two-dimensional layered material is selected from the group consisting of a class of graphite and a class of xenes.

8. The method of claim 1, wherein the two-dimensional material is selected from the group consisting of graphene, silicene, and stanene.

9. The method of claim 1, wherein the two-dimensional layered material is from the class of transition metal dichalcogenides of a general formula TX₂.

10. The method of claim 9, wherein in the general formula TX₂, T selected from the group consisting of molybdenum, tungsten, scandium, titanium, hafnium, zirconium, vanadium, chromium, manganese, iron, cobalt, nickel, niobium, technetium, tantalum, rhenium, palladium, and platinum and X is selected from the group consisting of sulfur, selenium, and tellurium.

11. The method of claim 1, wherein the two-dimensional layered material is from classes of mxenes.

12. The method of claim 11, wherein the two-dimensional material from classes of mxenes is selected from the group consisting of Ti₂C, (Ti_{0.5},Nb_{0.5})₂C, V₂C, Nb₂C, Mo₂C, Ti₃C₂, Ti₃CN, Zr₃C₂, Ti₄N₃, Nb₄C₃, Ta₄C₃, Mo₂TiC₂, Cr₂TiC₂, and Mo₂Ti₂C₃.

13. The method of claim 1, wherein the two-dimensional layered material is from classes of MAX-Phases, wherein the classes of MAX-Phases includes at least one of intercalated layered and non-intercalated layered 2D ternary transition metal carbides and nitrides.

14. The method of claim 1, wherein the primary mixture comprises CO₂ and O3 and the two-dimensional layered material is one of graphite and graphene.

15. The method of claim 1, wherein the primary mixture comprises CO₂ and O3 and the two-dimensional layered material is hexagonal boron nitride.

16. The method of claim 14, further comprising:
adding catalytic amounts of boron trihalogenide to the primary mixture.

17. The method of claim 15, further comprising:
adding catalytic amounts of boron trihalogenide to the primary mixture.

18. The method of claim 1, wherein the primary mixture comprises of O₃ and BX₃ and the two-dimensional layered material is hexagonal boron nitride.

19. The method of claim 1, wherein:
the primary mixture comprises one of boron trihalogenide and a mixture of CO₂ and boron trihalogenide; and
the two-dimensional layered material is a transition metal disulfide.

20. The method of claim 1, wherein the isolation of the functionalized and exfoliated 2D layered material comprises decompressing and evaporating the remainder of the primary mixture through a filter that holds the solid particle products back.

21. The method of claim 1, wherein the primary mixture comprises boron trihalogenide only and the 2D layered material is one of graphite and hexagonal boron nitride.

22. The method of claim 14, wherein the CO₂ provides a long term storage medium for graphene oxide and for other oxygen functionalized carbonaceous 2D layered materials.

23. The method of claim 1, wherein the inert solvent is present in any percentage of the 0 to 100 percentage range of a total of all molecules of the primary mixture.

24. The method of claim 1, wherein the at least one reactive component is present in any percentage up to 100 percentage range of a total of all molecules of the primary mixture.
